(19) United States
(12) Patent Application Publication
(10) Pub. No.: US 2012/0293447 A1
(43) Pub. Date: Nov. 22, 2012

(54) Circuits and Methods for Differentiating User Input from Unwanted Matter on a Touch Screen

(76) Inventors: Victor Phay Kok Heng, Punggol (SG); Soh Kok Hong, Serangoon (SG)

(21) Appl. No.: 13/109,862

(22) Filed: May 17, 2011

(51) Int. Cl. G06F 3/044

(52) U.S. Cl. 345/174

(57) ABSTRACT

A circuit includes an interface circuit configured to couple to a capacitive array of a touch screen and a driver circuit coupled to the interface circuit and configured to selectively provide signals to the interface circuit. The circuit further includes at least one sensor coupled to the interface circuit for detecting when a change in a capacitance of one a plurality of capacitances associated with the capacitive array exceeds a baseline threshold. The circuit further includes a control circuit coupled to the driver circuit and to the at least one sensor and configured to determine a fluctuation of the capacitance over a period of time. The control circuit determines that the change is caused by unwanted matter when the fluctuation is less than or equal to a noise threshold and by a user input when the fluctuation exceeds the noise threshold.

### FIELD

The present disclosure is generally related to touch-sensitive screens, and more particularly to circuits and methods for differentiating a contaminant from a user input in a touch screen.

### BACKGROUND

When a water droplet falls on a capacitive touch-screen panel, touch sensor circuitry can detects a change in an electrical parameter, such as a capacitance, that can be mistaken for a user input. The change can be similar to a user input corresponding to a user's finger or stylus touching the touch-screen panel, providing an undesired input.

### SUMMARY

In an embodiment, a circuit includes an interface circuit configured to couple to a capacitive array of a touch screen and a driver circuit coupled to the interface circuit and configured to selectively provide signals to the interface circuit. The circuit further includes at least one sensor coupled to the interface circuit for detecting when a change in a capacitance of one a plurality of capacitances associated with the capacitive array exceeds a baseline threshold. The circuit further includes a control circuit coupled to the driver circuit and to the at least one sensor and configured to determine a fluctuation of the capacitance over a period of time. The control circuit determines that the change is caused by unwanted matter when the fluctuation is less than or equal to a noise threshold and by a user input when the fluctuation exceeds the noise threshold.

In another embodiment, a method includes detecting a change in a capacitance of a capacitor within a capacitive array caused by an event when the change exceeds a baseline threshold and monitoring fluctuations in the capacitance over a period of time in response to detecting the change. The method further includes comparing the fluctuations to a noise threshold to determine a source of the change. When the fluctuations exceed a noise threshold, the source is determined to be a user input and when the fluctuations are less than or equal to the noise threshold, the source is unwanted matter.

In still another embodiment, a circuit includes an interface circuit configurable to couple to a capacitive array of a touch screen. Each capacitor of the capacitive sensor array includes a first current electrode and a second current electrode separated by a dielectric. The circuit further includes a capacitive driver circuit coupled to the interface circuit to scan the first current electrodes of the capacitive sensor array and a sensor circuit coupled to the interface circuit to receive signals from the second current electrodes of the capacitive sensor array and to provide a sensor output in response to receiving the signals. The circuit further includes a controller coupled to the capacitive driver circuit and to the sensor circuit. The controller detects a change that exceeds a baseline threshold based on the sensor output corresponding to a capacitor of the capacitive array and monitors fluctuations of the change over a period of time to differentiate between a user input and unwanted matter by comparing the fluctuations to a noise threshold.

### BRIEF DESCRIPTION OF THE DRAWINGS

FIG. 1 is a top view of an embodiment of a computing device including a touch-screen having a plurality of water droplets distributed thereon.

FIG. 2 is a block diagram of an embodiment of a system including a sensor circuit coupled to a touch screen and configured to differentiate between unwanted matter, such as a drop of water, and a user input.

FIG. 3 is a graph of a representative example of amplitude versus time for unwanted matter and a user input.

FIG. 4 is a block diagram of a second embodiment of a system including a sensor circuit configured to differentiate between unwanted matter and a user input.

FIG. 5 is a block diagram of an alternative embodiment of the sensor circuit of FIGS. 2 and 4.

FIG. 6 is a block diagram of a third embodiment of a system including a sensor circuit configured to differentiate between unwanted matter and a user input and including a self-capacitance touch screen circuit.

FIG. 7 is a flow diagram of an embodiment of a method for differentiating between a user input and unwanted matter as a source of a capacitive change in a capacitive array.

In the following description, the use of the same reference numerals in different drawings indicates similar or identical items.

### DETAILED DESCRIPTION OF ILLUSTRATIVE EMBODIMENTS

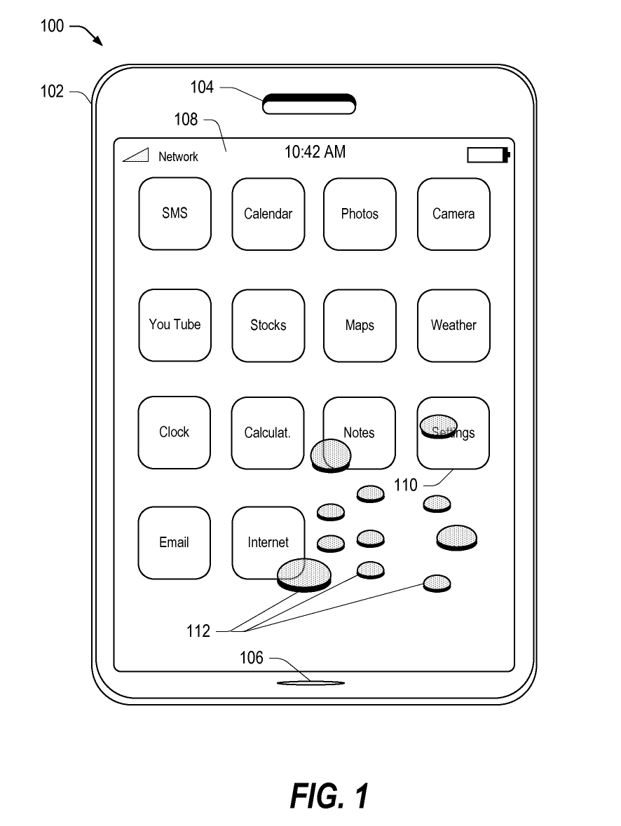

Embodiments of circuits and methods take advantage of the difference in the noise fluctuations to detect the presence of water and to distinguish whether a detected contact is caused by unwanted matter or a user input. In a particular example, a circuit utilizes a baseline threshold to detect a possible user input and then monitors the change over time to determine fluctuations associated with the capacitance at the “contact” location. If the fluctuations fall below a noise threshold, the circuit determines that the possible user input is due to unwanted matter and optionally adjusts the baseline threshold to eliminate (neutralize) future false positives at that location of the touch screen. In an example, unwanted matter exhibits a relatively low noise profile as compared to user inputs, which have relatively high noise profile because the user inputs include environmental noise picked up by the human body, slight movements by the user, contours of the skin, and so on. Thus, the circuit detects a user input when the fluctuations exceed the noise threshold. An example of a device that includes a circuit to differentiate between unwanted matter and user input is described below with respect to FIG. 1.

FIG. 1 is a top view of an embodiment of a computing device 100 including a touch-screen 108 having a plurality of water droplets 112 distributed thereon. In the illustrated example, computing device 100 is a cell phone. However, computing device 100 can be any electronic device configured to receive user input via a touch-sensitive interface, including a laptop computer with a track pad or touch screen, a portable music player, a personal digital assistant (PDA), pad computers, or another type of electronic device. Computing device 100 includes a housing 102 for securing the touch screen 108 and internal circuitry. Touch screen 108 includes a capacitive array, which produces electrical signals in response to user contact, and includes associated circuitry for detecting user input. Further, housing 102 includes a speaker opening 104 for permitting audio signals from a speaker (not shown) to pass from within the housing 102. Further, housing 102 includes a microphone opening 106 for permitting audio inputs through the housing 102 to a microphone (not shown).

As mentioned above, unwanted matter, such as water drops 112, contaminants, debris, or other extraneous material that is not intended to affect a user input, can fall onto the touch screen 108. Such unwanted matter may alter the capacitance at a particular location within the capacitive array, of the touch screen 108 to an extent sufficient to exceed a baseline threshold, providing a false indication of a user input. However, such unwanted matter presents a noise profile that differs from that of a user input. In particular, unwanted matter, such as water drops 112, exhibits less noise and/or capacitive fluctuations over time than contact by a user. Accordingly, circuitry within housing 102 monitors the change in the capacitance over a period of time to determine fluctuations in the capacitance. If the fluctuations fall below a noise threshold, the change can be ignored as being due to unwanted matter, whereas fluctuations that exceed the noise threshold represent a user input. An example of a circuit for differentiating between unwanted matter and a user input is described below with respect to FIG. 2.

FIG. 2 is a block diagram of an embodiment of a system 200 including a sensor circuit 202 coupled to a touch screen 204 and configured to differentiate between unwanted matter, such as a drop of water, and a user input. Touch screen 204 includes a capacitive array 210 formed from first electrodes 216 separated from second electrodes 218 by a dielectric. At each location where one of the first electrodes 216 crosses one of the second electrodes 218, a capacitor, such as capacitor 212, is formed.

Sensor circuit 202 includes a controller in the form of a micro control unit (MCU) 220. The controller can be an MCU (as shown), a data processor, a finite state machine, a logic circuit, or other circuits or combinations thereof that are configurable to perform the functions described below. The MCU 220 is coupled to one or more capacitive driver circuits 222, which are coupled to first conductors 206 that are coupled to first electrodes 216. Sensor circuit 202 further includes one or more capacitive sensors 226, which are coupled to MCU 220 and which may be coupled to second conductors 208 that are coupled to second electrodes 216. In some embodiments, second conductors 208 may be coupled to inputs of a multiplexer 224, which has a control input coupled to MCU 220 and an output coupled to an input of a capacitive sensor 226.

In an example, MCU 220 controls the one or more capacitive drivers 222 to selectively apply a signal to first conductors 206 and controls multiplexer 224 to provide signals on second conductors 208 to capacitive sensor 226 to scan for changes in the capacitances of the capacitive array 210. In an embodiment, MCU 220 controls the one or more capacitive drivers 222 to apply a signal pulse having a fixed duration to, each of the first electrodes 216 in a sequence and to scan the second electrodes 218 for signals indicating the capacitance. When a change in a particular capacitance of capacitive array 210 is detected that exceeds a baseline threshold, a possible contact is detected at a particular location within the capacitive array 210. In response to detecting the change, MCU 220 continues to monitor for fluctuations in the particular capacitance over time. If the fluctuations exceed a noise threshold, the change is determined to correspond to a user input, and otherwise the change is discarded as being due to unwanted matter. In the latter case, MCU 220 may adjust its baseline threshold for the particular capacitance to avoid false positives with respect to the unwanted matter. In an example, MCU 220 adjusts the baseline threshold to a level associated with a standard deviation of white noise with respect to the baseline threshold such that the unwanted matter is no longer detected as a change in capacitance. In some instances, the baseline threshold may be adjusted independently for each capacitance or for a selected subset of the capacitances of the capacitive array 210.

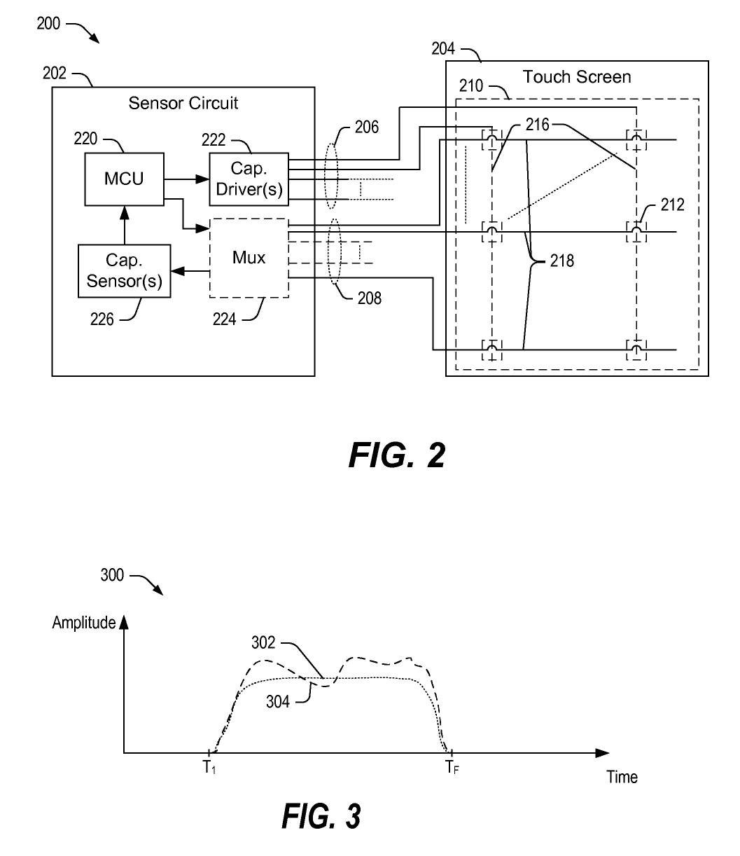

FIG. 3 is a graph 300 of a representative example of amplitude versus time for unwanted matter and a user input. Graph 300 depicts a first line 302 representing a signal on a second electrode of a particular capacitance of capacitive array 210 in response to an applied signal by capacitive driver 222. First line 302 represents a plurality of samples of the signal over a period of time from time T₁ to time T_{F}. First line 302 remains substantially constant over the period of time. In a particular example, first line 302 can represent accumulated samples over a plurality of scans of the capacitive array 210.

Graph 300 further depicts a second line 304 positioned over first line 302. Second line 304 represents an example of a user input over the same period of time. Second line 304 can represent a plurality of samples taken over a period of time. Unlike first line 302, second line 304 exhibits fluctuations over the period of time, which fluctuations can be used to distinguish a user input from unwanted matter.

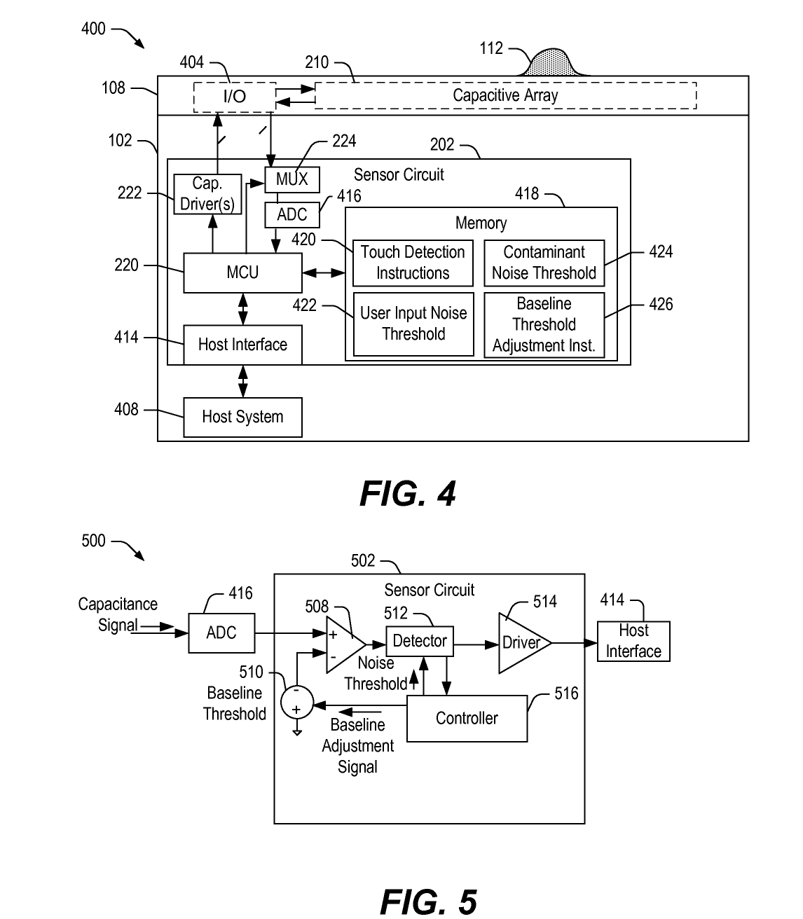

It should be understood that graph 300 and first and second lines 302 and 304 are illustrative only. In some implementations, capacitance measurements of a capacitance indicating a change due to unwanted matter may vary due to noise and circuit variations; however, a change due to user input will exhibit larger fluctuations, making it possible to differentiate between contaminants and user inputs. An example of a system including the sensor circuit 202 of FIG. 2 is described below with respect to FIG. 4.

FIG. 4 is a block diagram of a second embodiment of a system 400 including a sensor circuit 202 configured to differentiate between unwanted matter and a user input. System 400 includes a housing 102 defining a cavity sized to secure sensor circuit 202 and host system 408. Housing 102 is coupled to touch screen 108, which includes capacitive array 210 coupled to an input/output (I/O) interface 404.

Sensor circuit 202 includes capacitive drivers 222 including an input coupled to a controller in the form of MCU 220 and an output coupled to I/O interface 404. Sensor circuit 202 further includes a multiplexer 224 having inputs coupled to outputs of I/O interface 404, a control input coupled to. MCU 220, and an output coupled to an input of an analog-to-digital converter (ADC) 416, which includes an output coupled to MCU 220. Sensor circuit 202 further includes a host interface 414 coupled to MCU 220 and configurable to connect to host system 408. Further, sensor circuit 202 includes a memory 418 that is coupled to MCU 220.

Memory 418 stores instructions that, when executed by MCU 220, cause MCU 220 to detect a change in capacitance in the capacitive array 210 that is indicative of a possible user input, to differentiate between a change caused by a user input and a change caused by unwanted matter (such as water drops), and to adjust a baseline noise threshold when the change is due to contaminants. In particular, memory 418 stores touch detection instructions 420, one or more user input thresholds 422, contaminant instructions 424, and baseline threshold adjustment instructions 426.

In an example, in response to unwanted matter, such as water drop 112, capacitive array 210 produces an electrical signal indicating a change in at least one capacitance within the capacitive array 210. MCU 220 controls capacitive drivers 222 to apply signals to the capacitive array 210 and controls multiplexer 224 to selectively scan electrodes of the capacitive array 210 to detect the capacitances. Multiplexer 224 provides the electrical signals to ADC 416, which digitizes the electrical signals and provides them to MCU 220. MCU 220 executes touch detection instructions 420 to detect when the output of ADC 416 exceed a baseline threshold indicating a change in a capacitance. In response to detecting the change, MCU 220 monitors the change for fluctuations over a period of time. When the fluctuations exceed a user input noise threshold 422, MCU 220 provides a signal indicating a user input to host system 408 via host interface 414. When the fluctuations fall below user input noise threshold 422, MCU 220 executes contaminant instructions 424 to reset the touch detection and executes baseline threshold adjustment instructions 426 to adjust a baseline threshold associated with at least one of the capacitances of the capacitive array 210.

In an example, MCU 220 may adjust a baseline threshold for a selected one (or one or more) of the capacitances within the capacitive array 210. Further, baseline threshold adjustment instructions 426 may permit adjustment of user input noise thresholds for portions of or individual capacitances within capacitive array 210. In a particular embodiment, host system 408 may communicate updates and/or replacement instructions to MCU 220 through host interface 414, allowing sensor circuit 202 to be reprogrammed.

While host system 408 is depicted as being included within housing 102, in some instances, housing 102 may include an interface (not shown) for connecting to an input/output interface (not shown) of host system 408. In an example, the host system 408 can be a personal computer and the input/output interface can be a universal serial bus (USB) connection between the touch-sensitive device within housing 102 and the personal computer. In another instance, host system 408 can include a processor configured to execute other instructions, such as graphical user interface generating instructions and user application that utilize the user inputs detected by sensor circuit 202.

FIG. 5 is a block diagram of an alternative embodiment 500 of the sensor circuit 202 of FIGS. 2 and 4. In this embodiment 500, sensor circuit 202 includes a comparator 508 having an input coupled to an output of ADC 416, which has an input for receiving a capacitive signal from capacitive array 210. Comparator 508 includes a second input coupled to a baseline threshold 510 and an output coupled to an input of a detector 512. Detector 512 includes a first output coupled to an input of a controller 516, an input coupled to an output of controller 516, and an output coupled to an input of a driver 514, which has an output coupled to a host interface 414. Controller 516 can take the form of an MCU, a general purpose processor, a digital signal processor, a finite state machine, a digital logic circuit, or another circuit configurable to implement the functionality described herein. Controller 516 includes a control output coupled to baseline threshold 510 and is configured to provide a baseline adjustment signal to adjust the baseline threshold 510. Controller 516 is also configured to adjust a noise threshold of detector 512.

In this example, the output of the ADC 41.6 is compared to the baseline threshold 510 and a difference between the baseline threshold 510 and the output of ADC 416 is provided to detector 512. If, over time, the difference exceeds a noise threshold, detector 512 provides an output indicating the change to driver 514 for communication to host system 408 via host interface 414.

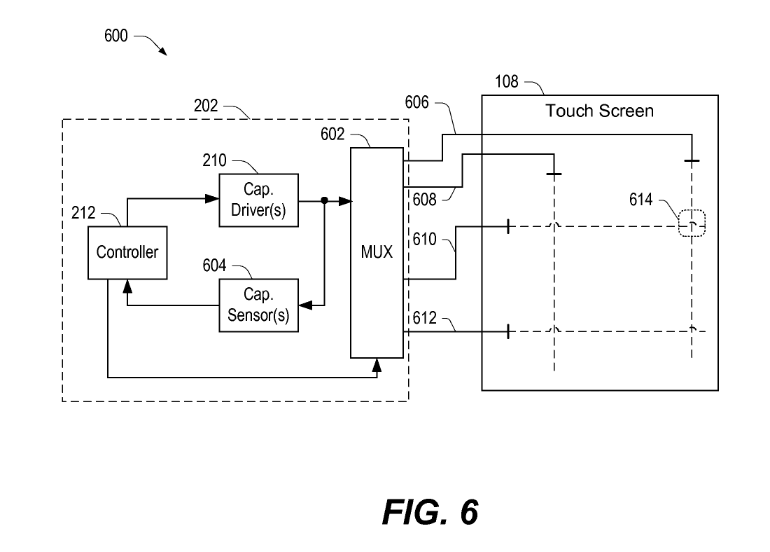

FIG. 6 is a block diagram of a third embodiment of a system 600 including a sensor circuit 202 configured to differentiate between unwanted matter and a user input and including a self-capacitance touch screen circuit 108. Sensor circuit 202 includes controller 212 having an output coupled to at least one input of one or more capacitive drivers 210, which have at least one output coupled to a multiplexer 602. Sensor circuit further includes one or more capacitive sensors 604, which include an input coupled to the output of one or more drivers 210 and an output coupled to MCU 210. Multiplexer 602 includes outputs coupled to lines 606, 608, 612, and 614, which extend within the touch screen circuit 108 to form a capacitive array.

In an example, controller 212 controls capacitive drivers 210 to drive line 606 via the multiplexer 602 and to sense for a capacitance change of tine 606. At the same time, the other lines 608, 610 and 612 are grounded. Controller 212 then controls capacitive drivers 210 to drive line 608 via multiplexer 602 and to sense for a capacitance change of line 608 while lines 606, 610 and 612 are grounded. Controller 212 iteratively cycles or scans through each of the lines 606, 608, 612, and 604 sequentially and one at a time. In this instance, a capacitance forms between the driven line, such as line 606, and the other lines net to and/or below the driven line. If there is a touch, such as at the location indicated at 610, then capacitive sensors 604 will detect a change in the capacitances of lines 606 and 610, indicating a touch signal, and controller 212 can determine (using firmware) that the touch has occurred at the intersection of line 606 and line 610.

As discussed above, if unwanted matter is presented at 610 that causes the change in the capacitances, the unwanted matter demonstrates less noise fluctuation than a finger, even if the finger remains in contact with the touch screen surface. Accordingly, controller 212 can examine multiple samples from capacitive sensors 604 to differentiate between unwanted matter and a user input. Further, as mentioned above, if unwanted matter is determined to be present at 610, controller 212 can adjust one or more thresholds of the capacitive sensors 604 such that the capacitance level associated with the unwanted matter is not detected as a “change” in capacitance. In other words, the threshold can be adjusted to neutralize or otherwise disregard the “change” in capacitance that is caused by the unwanted matter.

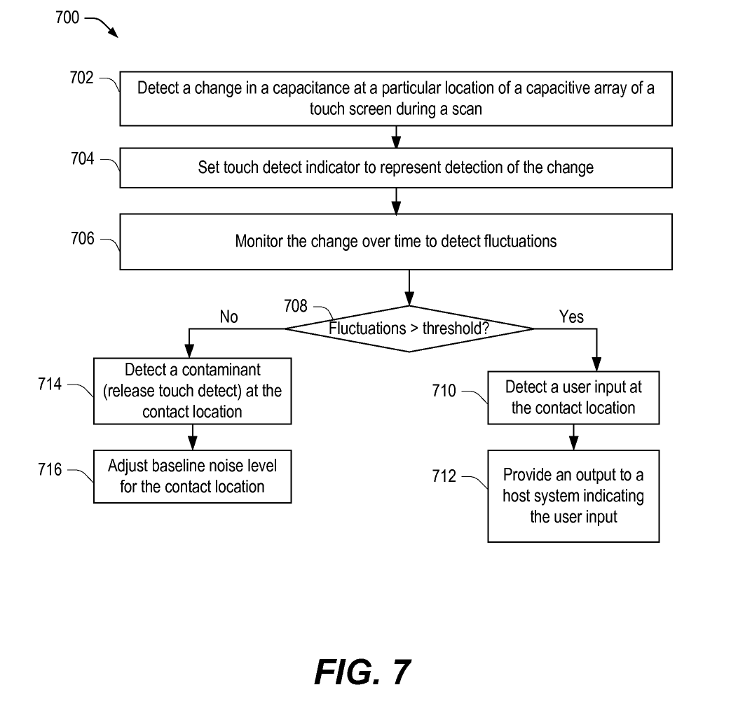

FIG. 7 is a flow diagram of an embodiment of a method 700 for differentiating between a user input and unwanted matter as a source of a capacitive change in a capacitive array. At 702, a change in a capacitance is detected at a particular location of a capacitive array of a touch screen. Advancing to 704, a touch detect is set to indicate detection of the change. Continuing to 706, the controller monitors the change over a period of time to detect fluctuations.

At 708, if the fluctuations exceed a noise threshold, the method 700 advances to 710 and a user input is detected at the contact location. Proceeding to 710, an output is provided to the host system indicating the user input.

Otherwise, at 708, if the fluctuations fall at or below the noise threshold, the method 700 continues to 714 and unwanted matter is detected at the contact location. In some instances, the touch detect indicator is also released. Moving to 716, a baseline noise level for the contact location is adjusted. In a particular example, the baseline noise level is adjusted to a level above a capacitive signal indicating the unwanted matter so that the unwanted matter will no longer trigger detection of the change in capacitance with respect to that particular location unless the change exceeds a higher threshold. The method 700 may then return to 702 to monitor for changes in the capacitance.

In general, even with the adjusted baseline, user contact with the touch screen will exceed the adjusted baseline threshold; however, subsequent scans of the capacitive array will overlook the capacitive change due to the unwanted matter. Further, while this allows the circuit to avoid a “stuck” condition when unwanted matter is spilled on the touch screen, while still allowing the circuit to detect user inputs.

In some instances, the configuration of method 700 may be varied while still allowing for differentiation of user inputs and contaminants. For example, in some instances, block 704 can be omitted. Further, additional blocks may be added. In a particular example, prior to detecting the change, the controller may control a capacitive driver circuit to apply a signal to a selected one of the first electrodes of the capacitive array and control the multiplexer to selectively scan the second electrodes of the capacitive array to detect an electrical signal. The change may be detected from the signals on the second electrodes.

In conjunction with the systems, circuits and methods described above with respect to FIGS. 1-7, a circuit is disclosed that includes an interface configured to couple to a capacitive array of a touch screen and a driver circuit coupled to the interface and configured to selectively provide signals to the interface. The circuit further includes at least one sensor coupled to the interface for detecting when a change in a capacitance of one a plurality of capacitances associated with the capacitive array exceeds a baseline threshold. The circuit further includes a control circuit coupled to the driver circuit and to the at least one sensor and configured to determine a fluctuation of the capacitance over a period of time. The control circuit determines the change is caused by a drop of water when the fluctuation is less than or equal to a noise threshold and by a finger contact when the fluctuation exceeds the noise threshold.

Although the present invention has been described with reference to preferred embodiments, workers skilled in the art will recognize that changes may be made in form and detail without departing from the scope of the invention.

What is claimed is:

1. A circuit comprising:
an interface circuit configured to couple to a capacitive array of a touch screen;
a driver circuit coupled to the interface and configured to selectively provide signals to the interface circuit;
at least one sensor coupled to the interface circuit for detecting when a change in a capacitance of a plurality of capacitances associated with the capacitive array exceeds a baseline threshold; and
a control circuit coupled to the driver circuit and to the at least one sensor and configured to determine a fluctuation of the capacitance over a period of time, the control circuit to determine that the change is caused by unwanted matter when the fluctuation is less than or equal to a noise threshold and by a user input when the fluctuation exceeds the noise threshold.

2. The circuit of claim 1, wherein the fluctuation represents noise.

3. The circuit of claim 1, further comprising:
a host interface circuit coupled to the control circuit and configured to couple to a host system; and
wherein the control circuit communicates detection of the user input to the host system through the host interface when the fluctuation exceeds the noise threshold.

4. The circuit of claim 1, wherein the control circuit comprises:
a multiplexer including a plurality of inputs coupled to a respective plurality of leads of the capacitive array, a control input, and an output;
a sensor including an input coupled to the output of the multiplexer and an output; and
a controller including an input couple to the output of the sensor, a control output coupled to the control input of the multiplexer, the controller configured to differentiate between the unwanted matter and the user input based on the fluctuation.

5. The circuit of claim I, wherein the control circuit adjusts the baseline threshold to a level that is substantially equal to the change in the at least one capacitance to prevent detection of the unwanted matter as an input signal.

6. The circuit of claim 5, wherein the control circuit adjusts the baseline threshold corresponding to a contact location of the capacitive array independent of the baseline threshold associated with other locations of the capacitive array.

7. The circuit of claim 1, wherein the circuit is included within a computing device.

8. A method comprising:
detecting a change in a capacitance of a capacitor within a capacitive array caused by an event when the change exceeds a baseline threshold;
monitoring fluctuations in the capacitance over a period of time in response to detecting the change; and
comparing the fluctuations to a noise threshold to determine a source of the change;
wherein the source comprises a user input when the fluctuations exceed a noise threshold; and
wherein the source comprises unwanted matter when the fluctuations are less than or equal to the noise threshold.

9. The method of claim 8, wherein the unwanted matter comprises at least one of a contaminant, debris, and a drop of liquid.

10. The method of claim 8, further comprising sending a signal to a host system via an interface when the source comprises the user input, the signal including location information related to a location of the capacitor within the capacitive array.

11. The method of claim 8, further comprising resetting the baseline threshold for the particular capacitor to a level associated with a standard deviation of white noise with respect to the baseline threshold when the source comprises the unwanted matter.

12. The method of claim 8, wherein monitoring fluctuations in the capacitance over the period of time comprises:
controlling a capacitive driver circuit to provide a signal to a conductive electrode of the capacitor;
receiving a signal indicating the capacitance of the capacitor at a capacitive sensor; and
providing the signal to a controller.

13. The method of claim 8, wherein the baseline threshold is below the noise threshold.

14. A circuit comprising:
an interface circuit configurable to couple to a capacitive array of a touch screen, each capacitor of the capacitive sensor array including a first current electrode and a second current electrode separated by a dielectric;
a capacitive driver circuit coupled to the interface circuit to scan the first current electrodes of the capacitive sensor array;
a sensor circuit coupled to the interface circuit to receive signals from the second current, electrodes of the capacitive sensor array and to provide a sensor output in response to receiving the signals; and
a controller coupled to the capacitive driver circuit and to the sensor circuit, the controller to detect a change that exceeds a baseline threshold based on the sensor output corresponding to a capacitor of the capacitive array, the controller to monitor fluctuations of the change over a period of time and to differentiate between a user input and unwanted matter by comparing the fluctuations to a noise threshold.

15. The circuit of claim 14, wherein the controller determines that the change corresponds to:
the user input when the fluctuations exceed the noise threshold; and
the unwanted matter when the fluctuations do not exceed the noise threshold.

16. The circuit of claim 15, wherein the unwanted matter comprises at least one of a contaminant, a drop of water, and debris.

17. The circuit of claim 14, wherein the MCU controls:
the capacitive driver circuit to apply a signal to one or more of the first current electrodes; and
the sensor circuit to scan the second current electrodes detect the signals corresponding to the capacitor.

18. The circuit of claim 14, wherein the controller adjusts the baseline threshold in response to determining that the change is caused by the unwanted matter.

19. The circuit of claim 18, wherein the controller adjusts the baseline, threshold to a level above a capacitive level associated with the change.

20. The circuit of claim 14, further comprising:
a host interface coupled to the controller and configurable to couple to a processor of a host system; and
wherein the controller provides a signal to the host system indicating the user input when the fluctuations exceed the noise threshold.
